(19) United States
(12) Patent Application Publication
(10) Pub. No.: US 2014/0033192 A1
(43) Pub. Date: Jan. 30, 2014

(54) EXPORTABLE DOCUMENT PROFILES

(71) Applicants: Jon Lorenz, San Francisco, CA (US); Kim P. Pimmel, San Francisco, CA (US)

(72) Inventors: Jon Lorenz, San Francisco, CA (US); Kim P. Pimmel, San Francisco, CA (US)

(21) Appl. No.: 12/135,692

(22) Filed: Jun. 9, 2008

(51) Int. Cl. G06F 9/44

(52) U.S. Cl. 717/171

(57) ABSTRACT

Apparatus, systems, and methods may operate to receive an electronic document and an associated document profile at a client. The client may then open the electronic document using a software application and configure the software application using the associated document profile. Additional apparatus, systems, and methods are disclosed.

### BACKGROUND

Software applications are used to view, edit, and manage electronic documents. Many software applications are configurable by a user, an administrator, or by an automatic mechanism. Configurations of software applications may be used to provide a customized user-experience. For example, a user may customize a software application by moving frequently-accessed tools in an easily-accessible toolbar.

### BRIEF DESCRIPTION OF DRAWINGS

Some embodiments are illustrated by way of example and not limitation in the figures of the accompanying drawings in which:

FIG. 1 is a schematic diagram illustrating a computer network system, according to an example embodiment, having a client-server architecture;

FIG. 2 is a flow chart illustrating a method, according to an example embodiment, of using a document profile to configure an application;

FIGS. 3A and 3B are diagrams illustrating a graphical user interface, according to example embodiments;

FIGS. 4A and 4B are diagrams illustrating a graphical user interface, according to example embodiments;

FIG. 5 is a block diagram of a system, according to various embodiments; and

FIG. 6 is a block diagram of an article of manufacture, according to various embodiments.

### DETAILED DESCRIPTION

For the purposes of this specification, the term “electronic document” includes any electronic media content. Examples of electronic documents include, but are not limited to, word processing files, image files, multimedia presentation files, audio recordings, video recordings, spreadsheet files, database files, rendered documents, and page descriptive formats. An electronic document may include any electronic content (e.g., digital data) that may be presented to a user (e.g., visually or audibly presented). In some embodiments, electronic content may include static content, such as text, pictures, drawing objects, tables, and the like. In some embodiments, electronic content may include dynamic content, such as a video recording, a movie, a documentary, a video sample clip, animation, and other like electronic content. In some embodiments, electronic documents may include a mixture of static and dynamic electronic content.

For the purposes of this specification, the term “online application” includes software applications that are provided in a networked, online environment. The software applications may have a client-server architecture, a peer-to-peer architecture, a distributed architecture, or other architectures using network infrastructures. In a client-server architecture, one example includes a web browser acting as the client and a web server acting as the server. Additional servers may be included to assist the web server in fulfilling its role, such as database servers, file servers, application servers, and the like. Online applications can include variations, such as web-based applications, thin-client applications, proprietary applications, or hybrid applications. Although many example embodiments described herein are discussed in terms of a web-based application, this specification is not limited to these types of applications, but instead may be implemented as any variation of an online application.

A “desktop software application” includes software applications that are provided to a user from a software application installed at the user's local machine. While some desktop software applications may include a networked component (e.g., an online help system or a mechanism to include hyperlinked material in an electronic document), the majority of the processing and implementation in a desktop application exists at the user's machine. Desktop software applications may include office suite types of applications, such as word processors, spreadsheet applications, databases, or presentation software. Desktop software applications may also include more specialized applications, such as a digital graphics editor (e.g., ADOBE® PHOTOSHOP®), a page descriptive format document editor (e.g., ADOBE® ACROBAT®), or an online content editor (e.g., ADOBE® FLASH®, ADOBE® DREAMWEAVER®, or ADOBE® COLDFUSION®).

Software applications may include online applications or desktop software applications, in various embodiments. In addition, some software applications may be implemented as a hybrid application: an application that has elements similar to online applications in addition to elements similar to those found in desktop software applications.

Certain applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). Modules may include hardware circuitry, optical components, single or multi-processor circuits, memory circuits, software program modules and objects, firmware, and combinations thereof, as appropriate for particular implementations of various embodiments. The term “module” includes an identifiable portion of code, data, or computational object to achieve a particular function, operation, processing, or procedure.

### Introduction

As computer users have become more connected to one another through the use of communication networks, the ability to share documents becomes increasingly more important. An authoring user may desire to create a document on one computer and then transmit the document to another user at a different computer. While some documents may include formatting data associated with the document (such as font specification, margins, page orientation, spacing, etc.) the authoring user may also want to transmit additional application configuration settings that are associated with a software application to a viewing user so that the viewing user's application can be configured to the same state as the authoring user's application. In another embodiment, a user may change computer systems such that application configuration information associated with a first computer system is not available on a second computer system. This application configuration information associated with an electronic document will be referred to as a “document profile.” By using a document profile that stores and provides the configuration information for an application, the application is configured to the same state when viewing the document at the new computer as it was when the user created the document at the previous computer. Thus, the user is presented with a familiar user interface at any computer that the user accesses to view or edit the document.

Document profiles may be created using a manual process or an automatic process, in example embodiments. For example, a user may wish to save a software application's settings to a document profile and activate a user interface control to initiate the creation, saving, or revising of a document profile. The document profile will be associated with the active document in the software application. As another example, software applications may include the ability to create, store, remove, or otherwise manage document profiles for each document opened or accessed via the software application. This may be included as a feature of the software application, in an example embodiment.

A document profile may be stored as a separate file from the document, or as an integral part of the document. In addition, the document profile may be stored using a standardized language format, such as eXtensible Markup Language (XML) or Unified Modeling Language (UML), for easier portability. A document profile may be stored as an integral part of an electronic document, but may be exportable to a separate file. An exported document profile may then be shared separate from the document that the document profile was exported from. For example, an exported document profile may be imported to and associated with a different document. This type of export-import mechanism provides application configuration sharing in a unique manner.

### System Overview

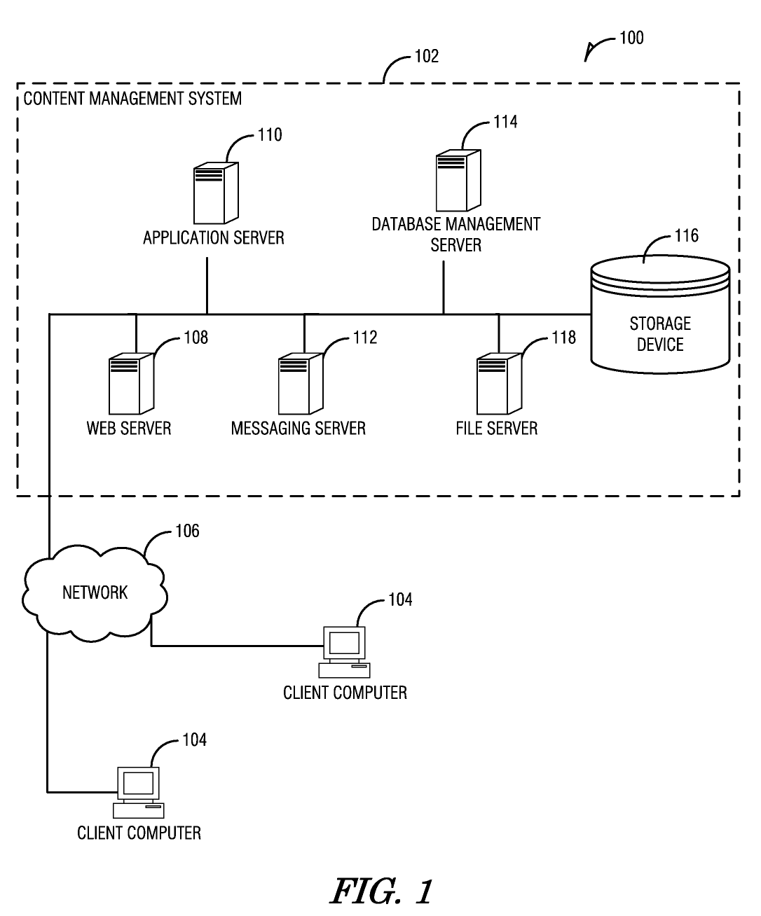

FIG. 1 is a schematic diagram illustrating a computer network system 100, according to an example embodiment, having a client-server architecture. The computer network system 100 includes a content management system 102 and one or more client computers 104, communicatively coupled via a network 106. In an embodiment, the content management system 102 includes a web server 108, an application server 110, a messaging server 112, a database management server 114, which is used to manage at least a storage device 116, and a file server 118. The content management system 102 may be implemented as a distributed system. For example, one or more elements of the content management system 102 may be located across a wide-area network from other elements of the content management system 102. As another example, a server (e.g., web server 108, file server 118, database management server 114) may represent a group of two or more servers, cooperating with each other, in providing a pooled, distributed, or redundant computing model.

The client computers 104 may comprise an electronic device in various forms, such as a mobile communication device (e.g., a PDA, a cellular phone, a smart phone, etc.), a laptop computer, a desktop computer, a dedicated client computing device (e.g., a kiosk), or other devices capable of network communication and visual presentation. In addition, the client computers 104 may include a thin-client, a thick-client, a fat client, a hybrid client, or other client model typically found in a client-server architecture.

The network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth® network) or other combinations or permutations of network protocols and network types. The network 106 may include a single local area network (LAN), wide-area network (WAN), or combinations of LANs or WANs, such as the Internet. The various devices coupled to the network 106 may be coupled to the network 106 via one or more wired or wireless connections.

The web server 108 may communicate with the file server 118 to publish or serve files stored on the file server 118. The web server 108 may also communicate or interface with the application server 110 to enable web-based presentation of information. For example, the application server 110 may provide scripts, applications, or library files that support primary or auxiliary functionality of the web server 108 (e.g., multimedia, file transfer, or dynamic interface functions). In addition, the application server 110 may provide some or the entire interface for the web server 108 to communicate with one or more other servers in the content management system 102, e.g., the messaging server 112 or the database management server 114. The web server 108, either alone or in conjunction with one or more other computers in the content management system 102, may provide a user interface. The user interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

In an embodiment, the client computer 104 may include a client program (e.g., a rendering program or rendering module) to interface with the content management system 102. The client program may include commercial software, custom software, open source software, freeware, shareware, or other types of software packages. In an embodiment, the client program includes a thin client designed to provide query and data manipulation tools for a user of the client computer 104. The client program may interact with a server program hosted by, for example, the web server 108 or the application server 110. Alternatively, the client program may interface with the database management server 114.

In addition, the client computer 104 may include one or more “helper applications.” A “helper application” includes software applications that work in conjunction with another application that may be considered a parent application to the helper application. For example, an Internet browser application (e.g., Microsoft Internet Explorer) may include one or more helper applications (e.g., plug-in applications or Browser Helper Objects) that enable a user to view a certain type of content. One example of a helper application in this context includes ADOBE® ACROBAT® READER® that allows a parent application (such as an Internet browser application) to view ADOBE® ACROBAT® formatted documents.

The storage device 116 may include a database, a memory, a disk, or similar devices. In an embodiment, the storage device 116 may comprise one or more logical or physical databases. For example, the storage device 116 may be viewed as a system of databases that when viewed as a compilation, represent a “storage device.” Sub-databases in such a configuration may include a document database, a user database, a document history database, an operations database, and the like. The storage device 116 may include a database implemented as a relational database, a centralized database, a distributed database, an object oriented database, or a flat database in various embodiments.

Some embodiments may include the various databases (e.g., storage device 116) being relational databases, flat files, XML based databases, object databases, or, in some cases, Online Analytic Processing (OLAP) based databases. In the case of relational databases, various tables of data are created and data is inserted into and/or selected from these tables using SQL or some other database-query language known in the art. In the case of OLAP databases, one or more multi-dimensional cubes or hyper cubes, including multidimensional data from which data is selected from or inserted into using a Multidimensional Expression (MDX) language, may be implemented. In the case of a database using tables and SQL, a database application (e.g., database products) such as, for example, MYSQL™, MICROSOFT SQL SERVER™, ORACLE 8I™, 10G™, or some other suitable database application may be used to manage the data. In this, the case of a database using cubes and MDX, a database using Multidimensional Online Analytic Processing (MOLAP), Relational Online Analytic Processing (ROLAP), Hybrid Online Analytic Processing (HOLAP), or some other suitable database application may be used to manage the data. The tables or cubes made up of tables, in the case of, for example, ROLAP, are organized into an RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

During operation, a user at a client computer 104 can access the content management system 102 to view an electronic document. The user may access a helper application to view, edit, or otherwise manage the electronic document. The electronic document may be stored, in whole or in part, at the storage device 116, file server 118, or web server 108, in various embodiments. In addition, the electronic document may be stored, in whole or in part, at the client computer 104 where the user is working.

The user may be given the option to create, update, or manage a document profile that is associated with the electronic document. The document profile can act to store an application configuration, which may be used to configure the application when the associated document is accessed at a later time. The document profile may be an integral part of the electronic document, for example, stored in a header or in a meta-data portion of the electronic document. The document profile may also exist as a separate file, or as separate data, from the electronic document. Separate storage may be advantageous as several people may want to access the same electronic document, but use different configurations based on personal preferences, system limitations, or the like.

At some time, the user may upload the electronic document to the content management system 102 along with a document profile. The document profile may be associated with a particular document and include information used when displaying the document in an application.

While the system 100 shown in FIG. 1 employs a client-server architecture, the present invention is of course not limited to such an architecture, and could equally well find application in a distributed, or peer-to-peer, architecture system, for example. Additionally, while various computers and storage devices are illustrated as separate components in FIG. 1, it is understood that functionality of these components may be merged, distributed, or otherwise organized into different configurations, depending on the implementations due to design preferences, cost restrictions, geographical limitations, or other business, technical, or practical considerations. Thus, the following paragraphs present only some of many potential embodiments that can be used in this respect.

### Methods for Using Document Profiles

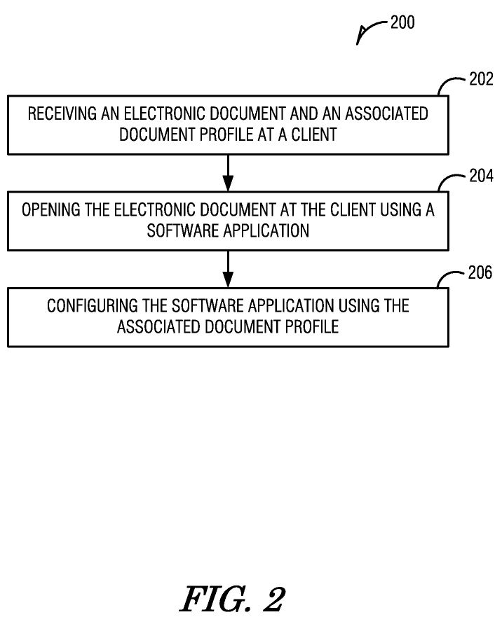

FIG. 2 is a flow chart illustrating a method 200, according to an example embodiment, of using a document profile to configure an application. At 202, an electronic document and an associated document profile are received at a client. The electronic document and the associated document profile are integrated into a single electronic file, in an example embodiment.

At 204, the client uses a software application to open the electronic document. The software application comprises a desktop software application, in an example embodiment. After opening the electronic document, the document may be revised using the software application. Revising the electronic document may alter the associated document profile, in an example embodiment. For example, a user may open a document to revise at least a portion of the document's contents. During revision, the user may change one or more printing settings related to the document. The printing settings may be captured in the document profile for use in subsequent accesses of the document. Other document revisions that may trigger a document profile update include, but are not limited to: altering a formatting setting, altering a style setting, altering a default format or style, altering a layout setting, altering a document format or type, altering a document language, or altering a document review mode.

At 206, the client configures the software application using the associated document profile. The software application may comprise a desktop software application, in an example embodiment. The software application may be configured in various ways, such as by modifying a toolbar setting, a font setting, an application preference, a security setting, or a user setting, in example embodiments.

Examples of modifying a toolbar setting include altering the visibility or placement of a toolbar, altering the arrangement of controls on one or more toolbars, and altering the controls included in one or more toolbars. Examples of modifying a font setting include configuring a default font, font size, or font treatment (e.g., italic, bold, underline). Examples of modifying an application preference include configuring spell checking, grammar checking, auto-save frequency, printer settings, network connectivity, and the like. Examples of modifying a security setting include configuring firewall, proxy, file transfer protocol (FTP), or hyper-text transfer protocol (HTTP) connection settings. Examples of modifying a user setting include configuring keyboard shortcuts, macros, toolbars, menus, or other user interface elements.

In an example embodiment, the document profile may be altered when an application configuration setting is changed. For example, when one or more of the software application settings described above are modified, the modified settings are captured in the document profile to be used to re-establish the software application's configuration when the document is accessed at a later time. The document profile may be automatically updated each time the user changes an application setting.

In a further embodiment, the electronic document and the associated document profile are stored in an online repository. The online repository may be implemented as a database, a distributed storage system, or as a file server, in various embodiments. The client may request access to the stored electronic document and associated profile. In an example embodiment, the document profile is stored at a separate location from the document, such as in a database, such that when a user accesses the document, the document profile is accessed and used to configure the software application. For example, the document may comprise a remote link, such as a hyperlink, in a document header. The remote link can be accessed by the software application when the document is opened to access the associated document profile. In an example embodiment, the remote link comprises a hypertext link, and the document profile is formatted using a standardized language format. In various embodiments, the standardized language format may comprise XML, HTML, SGML, or variants of such languages.

It should be noted that the methods described herein do not have to be executed in the order described, or in any particular order. Moreover, various activities described with respect to the methods identified herein can be executed in iterative, repetitive, serial, or parallel fashion. Activities within various methods may also be combined, to include combination across the various figures used herein.

Some example embodiments may include the above-illustrated operations being written as one or more software components. These components, and the functionality associated with each, may be used by client, server, or peer computer systems. These various components can be implemented into the system on an as-needed basis. These components may be written in an object-oriented computer language such that a component oriented or object-oriented programming technique can be implemented using a Visual Component Library (VCL), Component Library for Cross Platform (CLX), Java Beans (JB), Enterprise Java Beans (EJB), Component Object Model (COM), or Distributed Component Object Model (DCOM)), or other suitable technique. These components are linked to other components via various Application Programming Interfaces (APIs) and then compiled into one complete server and/or client application. The method for using components in the building of client and server applications is well known in the art. Further, these components may be linked together via various distributed programming protocols as distributed computing components.

### Example Implementations

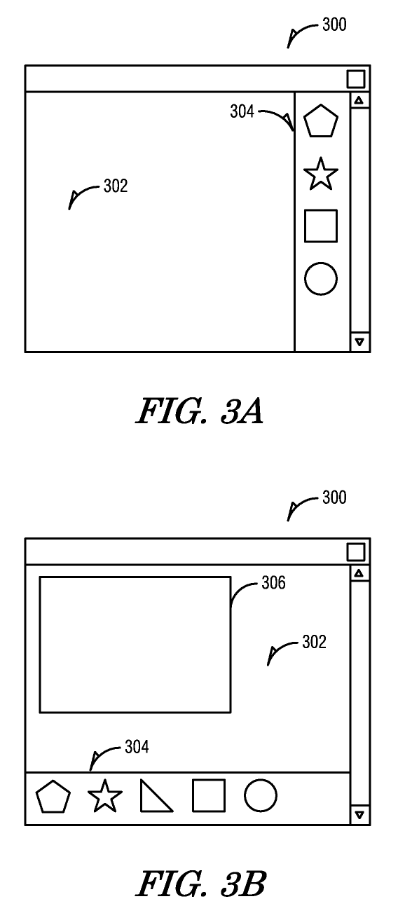

FIGS. 3A and 3B are diagrams illustrating a graphical user interface 300, according to example embodiments. In the embodiment illustrated, the graphical user interface 300 includes a document viewport 302 and an application toolbar 304. The document viewport 302 may be used to display one or more electronic documents in a tiled, windowed, or framed display. When more than one electronic documents are displayed using the document viewport 302, a user may navigate between available documents using keyboard or mouse actions, or combinations of keyboard and mouse actions. The application toolbar 304 includes one or more user interface controls to perform actions. The actions may be related to manipulating the one or more documents being rendered or displayed in the graphical user interface 300, such as saving, closing, or printing the active document. In addition, the actions may be related to managing or configuring the application associated with the graphical user interface 300, such as exiting the application, creating a new window or document viewport 302, or configuring the application toolbar 304. Those of ordinary skill in the art will recognize various configurations of the application toolbar 304 to implement the methods and systems described herein.

In FIG. 3A, the graphical user interface 300 is presented using a default state. The default state may be presented when the application first executes and before any documents are presented, for example. The default state may be configured by the user or a system configuration (e.g., a policy). In the example illustrated, the application toolbar 304 includes four controls, represented by the pentagon, star, square, and circle icons. These controls may represent various functions to manipulate an active document, manage the application, or access other applications, for example. While four controls are illustrated, it is understood that more or fewer controls may be provided in the application toolbar 304 depending on the configuration and abilities of the application.

FIG. 3B illustrates the graphical user interface 300 after a document 306 is opened. In the example illustrated in FIG. 3B, the application toolbar 304 has been altered based on a document profile (not shown) associated with the document 306 that was accessed by the application. The software application associated with the graphical user interface 300 may read the document profile and use one or more parameters described in the document profile to configure the software application. In this case, the application toolbar 304 has changed position (moving from the right side of the graphical user interface 300 to the bottom) and an additional control, the triangle icon, has been added.

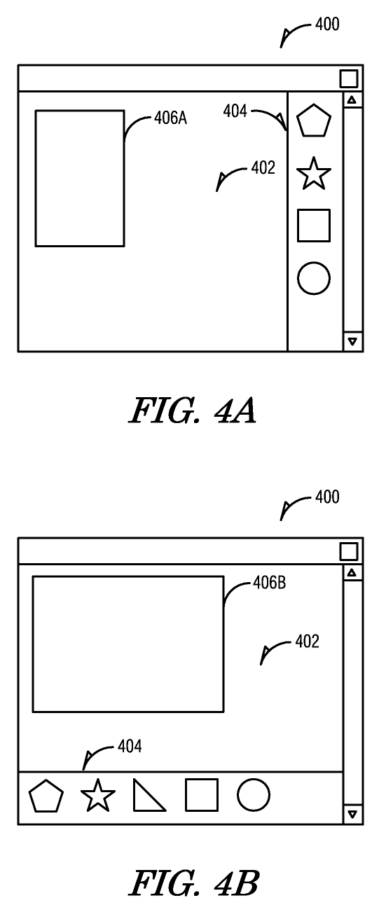

FIGS. 4A and 4B are diagrams illustrating a graphical user interface 300, according to example embodiments. Similar to the graphical user interface 300 illustrated in FIGS. 3A and 3B, FIG. 4A includes a document viewport 402 and an application toolbar 404 presented in the graphical user interface 400. FIG. 4A illustrates the state of the graphical user interface 400 when a first document 406A is being presented. In this state, the application toolbar 404 is positioned on the right side of the graphical user interface 400 and includes four control icons. The first document 406A may be associated with a first document profile (not shown), which was used to configure the graphical user interface 400 to the present state. In comparison, FIG. 4B illustrates the state of the graphical user interface 400 after a second document 406B has been made active. In this state, the application toolbar 404 has changed position and an additional control, the triangle icon, is included with the other previously-presented controls (the pentagon, the star, the square, and the circle control icons). Similarly, the changed state may be controlled using a second document profile (not shown) to configure the graphical user interface 400. Alternatively, the changed state may represent a default state, which is used when a document does not have an associated document profile. In an example embodiment, when the first document 406A loses focus, the associated first document profile is saved so changes are not lost if the application terminates unexpectedly. Similarly, when the state is changed back to reflect the state shown in FIG. 4A, any changes made to the second document profile may be saved for similar reasons.

Although not illustrated, it is understood that other aspects of the application may be configured, such as menu controls, shortcut keys, font settings, macros, and the like, as described above with respect to FIG. 2.

### Systems for Using Document Profiles

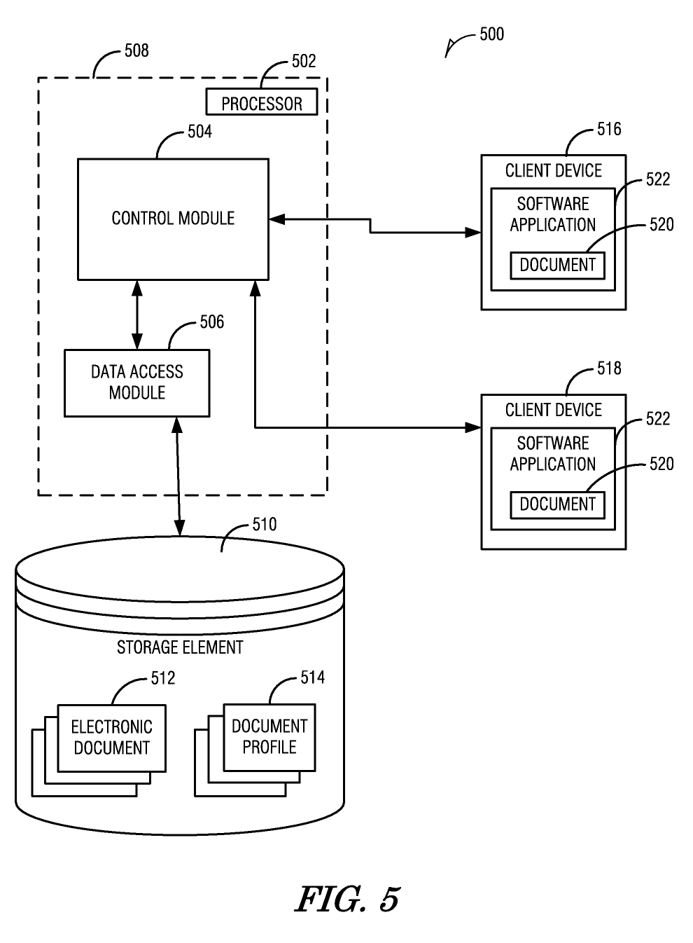

FIG. 5 is a block diagram of a system 500, according to various embodiments. The system 500 may include a number of modules such as one or more processors 502, a control module 504, and a data access module 506. These modules (502, 504, and 506) may be associated within a machine 508, as indicated by their containment within the dashed box. Those of ordinary skill in the art will understand that any of the modules (502, 504, or 506) shown to be located within the confines of the machine 508 may also be located outside the machine 508, and appropriately coupled to the machine 508 via wired or wireless connections.

The control module 504 may be used to manage access requests, write operations, and other operations related to electronic documents stored at the system 500 or at auxiliary systems. In some embodiments, the system 500 may include a web server, a database server, a transaction server, a business rules system, a customer relation management system, or combinations thereof. In general, the control module 504 allows users to store documents at the system 500, manage access rights to documents, retrieve documents, and delete documents.

The data access module 506 may be used by the control module 504 to access a storage element 510. The storage element 510 may include memory devices such as a database, a memory, a disk, or other storage device.

The storage element 510 may serve to store one or more electronic documents 512. The data access module 506 may operate to read from and/or write to the electronic documents and may provide reading and writing services for the benefit of other system modules, including the control module 504 and the processor 502. In addition, the storage element 510 may serve to store one or more document profiles 514, where each document profile is associated with one or more electronic documents 512 stored in the storage element 510.

The control module 504 may be operably coupled to client devices 516, 518. The client devices 516, 518 may comprise devices, such as a computer, a display screen, a handheld portable device, a kiosk, or other client devices used to present or display an electronic document. The client devices 516, 518 may be used to present an electronic document 520, for example, by using a software application 522.

In an example embodiment, a user may operate a client device 516 to author, revise, or otherwise manage an electronic document 520 using a software application 522. The user may then upload the electronic document 520 to the machine 508 to be stored at the storage element 510. A document profile may be generated and saved along with the electronic document. The document profile may be uploaded contemporaneously with the electronic document to be stored in the storage element 510. In an example embodiment, the electronic document and the document profile are integrated with each other in a single electronic file. In another example embodiment, the electronic document contains a reference to the document profile, which may be stored in a separate file, or even at a remote location, from the electronic document. For example, the control module 504 may include a web server and the electronic document may include a hypertext link to an associated document profile stored at the storage element 510, accessed via the web server (e.g., control module 504).

After the electronic document 520 and associated document profile is uploaded to the storage element 510, the user may access a second client device 518 to download the electronic document 520 and associated document profile. Using the document profile, the second client device 518 may configure the software application 522 executing at the second client device 518. This portable document configuration system provides the user a consistent user interface from whichever client device the user uses.

Some example embodiments may include remote procedure calls being used to implement one or more of the above-illustrated components across a distributed programming environment. For example, a logic level may reside on a first computer system that is located remotely from a second computer system including an interface level (e.g., a GUI). These first and second computer systems can be configured in a server-client, peer-to-peer, or some other configuration. The various levels can be written using the above-illustrated component design principles and can be written in the same programming language or in different programming languages. Various protocols may be implemented to enable these various levels and the components included therein to communicate regardless of the programming language used to write these components. For example, an operation written in C++ using Common Object Request Broker Architecture (CORBA) or Simple Object Access Protocol (SOAP) can communicate with another remote module written in Java™. Suitable protocols include SOAP, CORBA, and other protocols well-known in the art.

Some embodiments may use the Open Systems Interconnection (OSI) model or Transmission Control Protocol/Internet Protocol (TCP/IP) protocol stack model for defining the protocols used by a network to transmit data. In applying these models, a system of data transmission between a server and client, or between peer computer systems, is illustrated as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also includes port information for a recipient software application residing remotely. This TCP segment is loaded into the data load field of an IP datagram residing at the network layer. Next, this IP datagram is loaded into a frame residing at the data link layer. This frame is then encoded at the physical layer and the data transmitted over a network such as the Internet, a LAN, a WAN, or some other suitable network. In some cases, Internet refers to a network of networks. These networks may use a variety of protocols for the exchange of data, including the aforementioned TCP/IP, or some other suitable protocol. These networks may be organized within a variety of topologies (e.g., a star topology) or structures.

### Articles for Using Document Profiles

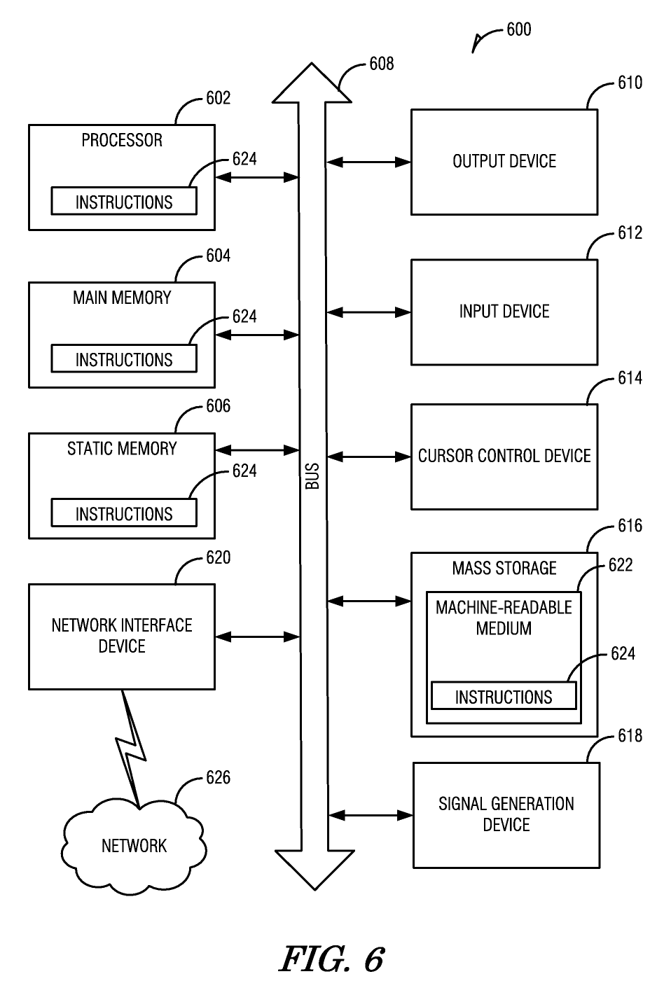

FIG. 6 is a block diagram of an article of manufacture 600, according to various embodiments. Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment.

Thus, other embodiments may be realized. For example, an article of manufacture, such as a computer, a memory system, a magnetic or optical disk, some other storage device, and/or any type of electronic device or system may include one or more processors 602 coupled to a machine-readable medium 622 such as a memory (e.g., removable storage media, as well as any memory including an electrical, optical, or electromagnetic conductor) having instructions 624 stored thereon (e.g., computer program instructions), which when executed by the one or more processors 602 result in performing any of the actions described with respect to the methods above.

Machine 600 may take the form of a computer system having a processor 602 coupled to a number of components directly, and/or using a bus 608. Such components may include main memory 604, static or non-volatile memory 606, and mass storage 616. Other components coupled to the processor 602 may include an output device 610, such as a video display, an input device 612, such as a keyboard, and a cursor control device 614, such as a mouse. A network interface device 620 to couple the processor 602 and other components to a network 626 may also be coupled to the bus 608. The instructions 624 may further be transmitted or received over the network 626 via the network interface device 620 utilizing any one of a number of well-known transfer protocols (e.g., HTTP). Any of these elements coupled to the bus 608 may be absent, present singly, or present in plural numbers, depending on the specific embodiment to be realized.

The processor 602, the memories 604, 606, and the storage device 616 may each include instructions 624 which, when executed, cause the machine 600 to perform any one or more of the methods described herein. In alternative embodiments, the machine 600 operates as a standalone device or may be connected (e.g., networked) to other machines. In a networked environment, the machine 600 may operate in the capacity of a server or a client machine in server-client network environment, or as a peer machine in a peer-to-peer (or distributed) network environment. The machine 600 may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine 600 is illustrated, the term “machine” shall also be taken to include any collection of machines that individually or jointly execute a set (or multiple sets) of instructions to perform any one or more of the methodologies discussed herein. The machine 600 may be similar to or identical to the machine 508 of FIG. 5.

While the machine-readable medium 622 is shown as a single medium, the term “machine-readable medium” should be taken to include a single medium or multiple media (e.g., a centralized or distributed database, and/or associated caches and servers, and or a variety of storage media, such as the processor 602 registers, memories 604, 606, and the storage device 616) that store the one or more sets of instructions 624. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include tangible media, such as solid-state memories and optical and magnetic media.

### Conclusion

Although embodiments of the invention have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those of ordinary skill in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Embodiments may, for example, be implemented as a stand-alone application (e.g., without any network capabilities), a client-server application or a peer-to-peer (or distributed) application. Embodiments may also, for example, be deployed by Software-as-a-Service (SaaS), Application Service Provider (ASP), or utility computing providers, in addition to being sold or licensed via traditional channels.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of ordinary skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer-implemented method comprising:
receiving, by a first computer system from an online repository, an electronic document and a corresponding document profile that is a separate file specific to and received with the electronic document, the corresponding document profile providing configuration information used to configure a software application when the electronic document that corresponds to the document profile is opened, the configuration information not provided on the first computer system;
executing, at the first computer system, the software application, the software application providing a graphical user interface in a first state; and
in response to opening of the electronic document, configuring the software application using the configuration information from the corresponding document profile that is received with the electronic document from the online repository, the configuring comprising altering presentation of the graphical user interface within which the electronic document is displayed to a second state that is a same state as when the electronic document and the corresponding document profile were last saved to the online repository.

2. The computer-implemented method of claim 1, further comprising:
transmitting a request from the first computer system to the online repository to access the document.

3. The computer-implemented method of claim 1, further comprising:
revising the electronic document using the software application to provide a document revision; and
updating the corresponding document profile based on the document revision.

4. The computer-implemented method of claim 3, wherein the software application comprises a desktop software application.

5. The computer-implemented method of claim 1, further comprising:
storing the electronic document and the corresponding document profile in the online repository.

6. (canceled)

7. The computer-implemented method of claim 1, wherein configuring the software application using the configuration information from the document profile received with the electronic document from the online repository comprises:
modifying at least one of: a toolbar setting, a font setting, an application preference, an application setting, a security setting, or a user setting.

8. A machine-readable non-transitory storage medium including instructions, which when executed by a machine, cause the machine to perform operations comprising:
receiving, by a first computer system from an online repository, an electronic document and a corresponding document profile that is a separate file specific to and receivable with the electronic document, the corresponding document profile providing configuration information used to configure a software application when the electronic document that corresponds to the document profile is opened, the configuration information not provided on the first computer system;
executing, at the first computer system, the software application, the software application providing a graphical user interface in a first state; and
in response to opening of the electronic document, configuring the software application using the configuration information from the corresponding document profile that is received with the electronic document from the online repository, the configuring comprising altering presentation of the graphical user interface within which the electronic document is displayed to a second state that is a same state as when the electronic document and the corresponding document profile were last saved to the online repository.

9. The machine-readable medium of claim 8, further comprising instructions, which when executed by the machine, cause the machine to perform operations comprising:
detecting a change in configuration of the software application; and
updating the corresponding document profile based on the change in the configuration.

10. The machine-readable medium of claim 8, further comprising instructions, which when executed by the machine, cause the machine to perform operations comprising:
transmitting the electronic document and the corresponding document profile to the online repository.

11. (canceled)

12. The machine-readable medium of claim 8, wherein configuring the software application further comprises instructions, which when executed by the machine, cause the machine to perform operations comprising:
modifying at least one of: a toolbar setting, a font setting, an application preference, an application setting, a security setting, or a user setting.

13. The machine-readable medium of claim 8, wherein configuring the software application further comprises instructions, which when executed by the machine, cause the machine to perform operations comprising:
determining a location of the document profile that corresponds to the electronic document;
accessing the document profile from the location; and
using the document profile to configure the software application in response to opening of the electronic document.

14. A system comprising:
a processor of a machine; and
a software application, coupled to the processor of the machine, and configured to:
open a first electronic document that is received from an online repository at a first computer system, using a software application, the software application presenting the electronic document within a graphical user interface in a first state;
access a first document profile that corresponds to and was received with the first electronic document from the online repository, the first document profile being a separate file specific to the first electronic document and providing configuration information used to configure the software application when the electronic document corresponding to the document profile is opened, the configuration information not provided on the first computer system; and
configure the software application using the configuration information from the first document profile, the configuring of the software application comprising altering presentation of the graphical user interface within which the electronic document is displayed to a second state that is a same state as when the electronic document and the corresponding document profile were last saved to the online repository.

15. The system of claim 14, wherein the software application is further configured to:
open a second electronic document;
access a second document profile, the second document profile being a separate file specific to and receivable with the second electronic document; and
configure the software application using the second document profile to present the second document in a third state that is a same state as when the second electronic document was last saved to the online repository.

16. The system of claim 15, wherein the software application is further configured to:
detect when the first or second electronic document is active; and
configure the software application using the respective first or second document profile according to which electronic document is active.

17. The system of claim 14, wherein the software application is further configured to:
update and save the first document profile contemporaneously with the saving of the corresponding first electronic document.

18. The system of claim 14, wherein the first document profile is formatted using XML.

19. The system of claim 14, wherein the software application is further configured to:
transmit the first electronic document contemporaneously with the first document profile to the online repository causing the first document profile to be portable with the first electronic document.

20. The system of claim 14, wherein the software application is further configured to:
modify at least one of: a toolbar setting, a font setting, an application preference, an application setting, a security setting, or a user setting, when configuring the software application using the first document profile.

21. The method of claim 1, wherein the last save of the electronic document causes a save of the configuration information in the document profile that corresponds to the electronic document.

22. The method of claim 21, wherein the saving of the electronic document and the document profile occurs at a second user device, the second user device uploading the electronic document and document profile to the online repository resulting in the document profile being portable with the electronic document.
